(19) United States
(12) Patent Application Publication
(10) Pub. No.: US 2024/0372486 A1
(43) Pub. Date: Nov. 7, 2024

(54) QUASI-SINUSOIDAL VARIABLE CAPACITOR

(71) Applicant: Andrew Ward, Bozeman, MT (US)

(72) Inventor: Andrew Ward, Bozeman, MT (US)

(21) Appl. No.: 18/312,312

(22) Filed: May 4, 2023

(51) Int. Cl. H02N 1/00; H02N 1/08

(52) U.S. Cl. CPC H02N 1/004; H02N 1/08

(57) ABSTRACT

A quasi-sinusoidal variable capacitor, comprising a stator and a rotor, is disclosed. Its stator and rotor are housed within a vacuum chamber. The stator is fixedly attached to a non-conductive stator mount within the vacuum chamber. The stator includes at least two sub-assemblies of stator pole plates. These stator pole sub-assemblies are electrically isolated from one another, whereas the sub-assemblies' stator plates are in electrical communication with one another. The rotor, through a rotor shaft, is rotatably coupled to the stator mount. The rotor includes a non-conductive rotor mount and conductive rotor segments. The rotor segments are evenly spaced around and fixedly attached to the rotor mount. These rotor segments are electrically isolated from one another. Electrical charge within the stator's capacitance causes electrostatic induction within these rotor segments. Rotation of the rotor varies this electrostatic induction within the rotor segments, establishing a quasi-sinusoidal variance in the stator's capacitance.

### TECHNICAL FIELD OF THE INVENTION

The present disclosure relates to energy conversion devices. More particularly, this disclosure is related to quasi-electrostatic motors and generators.

### DESCRIPTION OF THE PRIOR ART

The following is a chronological list of prior art related to this disclosure. Dezsö Korda taught us how to design a variable air gap capacitor in 1893. Noel Felici then modified this design in 1946, teaching us that a rotating electrostatic device can produce electricity. Ferdinand Cap further improved on this series of designs in 1982 by teaching us how to achieve electrical resonance within a parametric electric machine. Peter Salmon taught us in 2006 about an energy converter utilizing electrostatics. Also in 2006, Toshiiku Sashida taught us how to build an electrostatic motor. Finally, the author of this disclosure, Andrew Ward, taught how to design a capacitive alternator in 2019. Continuing from this research on capacitive alternators, the author wrote a peer reviewed conference article, Modeling Energy Creation with a Lagging Current and a Quasi-Sinusoidal Variance in Capacitance, in 2022. This conference article, which is available in IEEE Xplore, likewise covers the findings presented within this disclosure.

### BACKGROUND OF THE INVENTION

The law of conservation of energy is often referred to as the first law of thermodynamics. Written algebraically as ΔÛ=\hat{Q}−W, this law states that the change in the internal energy of a system ΔÛ is equal to the thermal energy transferred through the system \hat{Q}, minus the work W the system does on its surroundings. The law of conservation of energy is accurate in terms of heat engines because thermal energy itself does no work. Heat engines convert thermal energy that is being transferred from a hot reservoir to a cold reservoir into mechanical energy. It is this heat which is converted into work, not the thermal energy itself. Likewise, magnetic fields do no work. The equation F=Q (B×ν), states that a magnetic field B applies a perpendicular force F onto a charge Q that is moving perpendicularly to the field with velocity ν. Magnetic fields do no work because their fields force charges to move perpendicularly to themselves rather than parallel to themselves. Therefore, magnetic fields can convert energy from one form into another but cannot create energy because their fields do no work.

The law of conservation of energy was formed roughly one-hundred and eighty years ago by scientists such as James Joule, Émilie du Châtelet and William Rankine. These scientists determined that the energy of a system is conserved because transferring thermal energy was found to produce a proportional amount of work, that is ΔÛ=\hat{Q}−W. However, this disclosure provides evidence that the law of conservation of energy inaccurately describes the physical characteristics of quasi-electrostatic fields, which can do work on their neighboring charges. This disclosure suggests a modification to the law of conservation of energy in order to remedy this inaccuracy.

The following is a partial list of relevant technological advancements and their approximate dates of discovery. These advancements were necessary in uncovering the inaccuracy within the law of conservation of energy but were unavailable in the 1840s. In chronological order, the Sprengel pump, a pump capable of achieving a high vacuum, was created in 1865. Electrical resonance was first calculated by James Maxwell in 1868, however, the first practical use of an RLC circuit wasn't until the 1890s, when used in spark-gap radio transmitters. The synchronous motor was created in 1869 but was not widely accepted until the 1920s. Then, this disclosure's predecessor, the variable air gap capacitor, was patented in 1893. Taking a different approach, personal computers were first made widely available in the 1970s. While John Rayleigh first developed the mathematics of finite element analysis (FEA) in the late 1800s, Ansys, the FEA software used to develop the quasi-sinusoidal variable capacitor wasn't founded until 1970. Furthermore, the world wide web was developed in the 1990s, which has brought greater access to the acquisition of knowledge. It was not until the 2010s that the use of personal computers, the world wide web, and advanced simulation software became affordable and easy to use by the public.

This partial list of technological advancements intends to show that the inaccuracy within the law of conservation of energy was only capable of being discovered because of the vast number of technological advancements that have been made since the 1840s. This inaccuracy was recognized after identifying the law of conservation of energy as a logical fallacy. The law of conservation of energy was formed due to the lack of evidence that energy could be created, however a lack of evidence is not evidence in and of itself. This type of logical fallacy, providing a lack of evidence as evidence, is known as an appeal to ignorance. It must be rationalized that a scientific law cannot be both accurate and illogical simultaneously, therefore the law must be revisited. Albert Einstein provided great wisdom towards the subject of ignorance and revisitation when he stated, “Everyone knew it was impossible, until a fool who didn't know came along and did it.”

### SUMMARY OF THE INVENTION

This disclosure proposes that the law of conservation of energy would be more accurately stated as the law of conservation of work. This modification accurately reflects the evidence used to justify the law of conservation of energy. While transferring thermal energy does work, neither thermal energy nor magnetic fields do work; their work is conserved. For example, a heat engine uses the transfer of thermal energy to do work on its surroundings. However, the amount of work done by the engine is always less than the thermal energy transferred through it, because the thermal energy itself adds no work to the system. In simpler terms, an amount of mechanical energy is required to produce a slightly lesser amount of electrical energy within induction generators because their magnetic fields add no work to the system. On the contrary, the equation W=QE·d states that an electric field E does work onto a charge Q by forcing it to move a distance d parallel to the field itself. Electric fields can independently add work to a system because the fields themselves do work. Therefore, the law of conservation of work describes the ability to create energy from the work added to a system by an electric field.

With rotating machines, the work done onto their rotor is equal to W=∫_{θ}_{₁}^{θ}^{₂}τ(θ)dθ. Whereas the quasi-sinusoidal variable capacitor's torque is approximately equal to:

$${τ}_{Rotor} ( {θ}_{t} ) ≅ \frac{1}{2} \frac{{Q ( t )}^{2}}{C ( {θ}_{t} )} \frac{\frac{d}{d θ} C ( {θ}_{t} )}{C ( {θ}_{t} )} {α}_{Fit} . \qquad ( 1 )$$

The embodiment dependent constant α_{Fit} relates the force

$$F = \frac{1}{2} \frac{{Q}^{2}}{{C}^{2}} \frac{dC}{dx}$$

a capacitor C has on a dielectric medium, to the torque measured in Ansys. The rotor's angle of rotation at time t is θₜ. Equation (1) states that the rotor's torque is a function of the rate of change of the stator's capacitance and not a function of the rate of change of the stator's charge, as it is with induction generators. Therefore, the work done by the electric field onto the rotor is proportional to the potential energy stored within the stator's capacitance

$$U = \frac{1}{2} \frac{{Q ( t )}^{2}}{C ( {θ}_{t} )}$$

and the ratio of the rate of change of the stator's capacitance to the stator's capacitance

$$\frac{\frac{d}{d θ} C ( {θ}_{t} )}{C ( {θ}_{t} )} .$$

According to W=QE·d, the work done by the electric field E does not directly change the potential energy of the electric field itself

$$U = \frac{1}{2} ε {E}^{2} Ad .$$

There is not a direct reduction of E in the equation W=QE·d, such as W≠Q(E−ΔE)·d. The work done by the force per charge E, does not directly reduce the amplitude of the force itself, nor its ability to do work. Rather, the electric field is indirectly changed by the variance in its host's capacitance

$$\frac{d}{d θ} C ( {θ}_{t} ) ,$$

as described by equation (1). This disclosure illustrates how to take advantage of the law of conservation of work, and the work added to a system by electric fields to create energy with a quasi-sinusoidal variable capacitor.

Energy can be created with a quasi-sinusoidal variable capacitor when an alternating stator charge's peak occurs while the stator's capacitance is slowly decreasing, and when its other peak occurs while the stator's capacitance is quickly increasing. This is possible because the work done by the electric field is conserved. To clarify, an increasing stator capacitance accelerates the rotor forward because the electric field does work onto the rotor in order to lower the system's total potential energy. Likewise, work is required to accelerate the rotor forward while the stator's capacitance is decreasing, because in doing so the system's total potential energy is increased. Being that this work is proportional to the rate of change of the stator's capacitance, mechanical energy can be created when the peaks of an alternating stator charge are present while these two rates are unequal. Mechanical energy can be created because the electric field's work onto the rotor is conserved, whereas the system's total energy is not.

The objective of the quasi-sinusoidal variable capacitor is to create energy from the work done by an electric field. This device has been simulated within Ansys and MapleSim (circuit analysis software) as having over-unity efficiency (produces more energy than it consumes) while operating as a generator. It has also been simulated as a motor that does not require input energy during operation, and as both a generator and a motor simultaneously. This device can create both mechanical and electrical energy simultaneously if, and only if, the work done by the electric field is conserved.

The quasi-sinusoidal variable capacitor can be summarized as a capacitive stator and an electrically isolated rotor, which upon rotation of the rotor the stator's capacitance is varied. The device's stator and rotor are specifically designed to produce a quasi-sinusoidal variance in the stator's capacitance. In this case, a quasi-sinusoidal variance is a waveform whose mean is greater than its medians (the mid-points between its maximum and minimum capacitances). Alternatively, a sinusoidal variance has a mean that is equal to its medians. This quasi-sinusoidal design allows for a lagging alternating stator charge's peak to occur while the stator's capacitance is slowly decreasing, and its other peak to occur while the stator's capacitance is quickly increasing. As stated, this device can create energy with a lagging current and its quasi-sinusoidal variance in capacitance.

### BRIEF DESCRIPTION OF THE FIGURES

The figures presented in this disclosure provide illustrations of a quasi-sinusoidal variable capacitor, plots and tables related to its operation, system level views of the device, and a table describing the enumeration schemes used within the figures. Due to computational constraints, the plots and tables presented within this disclosure are from the simulation of a single rotor disc embodiment that was previously disclosed in the conference article, Modeling Energy Creation with a Lagging Current and a Quasi-Sinusoidal Variance in Capacitance. However, the geometric illustrations of the multi rotor disc embodiments within this disclosure represent the device's preferred embodiments.

FIG. 1 is a partial isometric view of a coplanar embodiment of a quasi-sinusoidal variable capacitor. It illustrates the major features of the device's capacitive stator.

FIG. 2 is a partial isometric view similar to that of FIG. 1; however, the stator pole plates S.1.1 and S.2.1 are transparent to provide greater detail of the rotor disc R.1. FIG. 2 illustrates the major features of the device's rotor relative to the stator.

FIG. 3 is an isometric view of the third stator pole S.3 of the embodiment of FIG. 1.

FIG. 4 is a front view of the rotor disc R.1 of the embodiment of FIG. 2.

FIG. 5 is a partial top view of the embodiment of FIG. 1. It illustrates the configuration of the rotor relative to the stator.

FIG. 6 is a front view of the embodiment of FIG. 1, which illustrates important geometric features of the stator and stator mount.

FIG. 7 is a partial top view taken along the section line 7-7 of FIG. 6. Specifically, it details important geometric features of the stator and rotor.

FIG. 8 is a partial isometric view similar to that of FIG. 1; however, this embodiment has only two stator poles compared to the embodiment of FIG. 1, which has four stator poles.

FIG. 9 is a partial isometric view similar to that of FIG. 2. This embodiment is like that of FIG. 8 in that it has only two stator poles.

FIG. 10 is a table of eight partial front views of the embodiment of FIG. 1. The stator pole plates S.1.1 and S.4.1 are transparent to show greater detail of the rotor disc R.1 relative to the stator. Specifically, FIG. 10.a through FIG. 10.h demonstrates how the rotation of the rotor establishes a quasi-sinusoidal variance in the stator's capacitance.

FIG. 11 is a plot of a stator's series quasi-sinusoidal variance in capacitance per rotor segment. It also provides a sinusoidal variance in capacitance as a reference.

FIG. 12 is a plot of the rotor's torque proportionalities related to the variances in capacitance of FIG. 11.

FIG. 13 is an equivalent circuit model of a quasi-sinusoidal variable capacitor, its inductive circuit, and its DC voltage source.

FIG. 14 is an equivalent circuit model of two assemblies, A and B, of a quasi-sinusoidal variable capacitor, their inductive circuits, and their shared DC voltage source.

FIG. 15 is a plot of the two assemblies' stator series capacitances of FIG. 14.

FIG. 16 is a plot of the two assemblies' rotor torque proportionalities of FIG. 14 and FIG. 15. It also provides their resulting combined torque proportionality.

FIG. 17 is a snapshot plot of the two assemblies' stator currents per rotor segment, for one variation of the equivalent circuit of FIG. 14 and the resulting combined current that flows through their shared DC voltage source.

FIG. 18 is a snapshot plot of the alternating combined current of FIG. 17 relative to the pulsing DC generator voltage from the DC voltage source of FIG. 14.

FIG. 19 is a snapshot plot of the instantaneous DC generator power associated with the alternating combined current flowing through the DC generator voltage of FIG. 18 and its average output.

FIG. 20 is a table of snapshot plots of the stator's alternating charge for six variations of the equivalent circuit of FIG. 13. FIG. 20.a through FIG. 20.f demonstrate how the charge within the stator's capacitance differs as the circuit's variations range from being capacitive to inductive.

FIG. 21 is a line graph relating the stator charges' electrical phase from the equivalent circuits of FIG. 13 and FIG. 14 to their corresponding rotors' mechanical angle of rotation.

FIG. 22 is a snapshot plot of the instantaneous power associated with one variation of the equivalent circuit of FIG. 14 and their average outputs.

FIG. 23 is a plot of the average power flowing through the DC generator and the electrical load, as well as the mechanical power associated with the rotation of the rotor for the equivalent circuit of FIG. 14 with respect to the circuit's inductance. It plots the combined average output, Ave Output, of these three power plots.

FIG. 24 is a plot of the average power flowing through the DC generator and the electrical load, the mechanical power associated with the rotation of the rotor, and their combined output for one variation of the equivalent circuit of FIG. 14 with respect to time.

FIG. 25 is a table of snapshot plots of the mechanical power associated with four variations of the equivalent circuit of FIG. 14 relative to the combined torque proportionality of FIG. 16. Specifically, FIG. 25.a through FIG. 25.d demonstrate how the instantaneous and average mechanical power associated with this equivalent circuit increases as the circuit's variations range from being resonant to inductive.

FIG. 26 is a table of fifteen variations of the equivalent circuit of FIG. 13. It provides the variation's inductance and resistance, and the current's resulting mechanical phase angle. In addition, it provides the average electrical and mechanical power, as well as their combined average output, for each of the variations.

FIG. 27 is a simplified system level view of the quasi-sinusoidal variable capacitor, an inductive circuit, and a synchronous motor-generator set.

FIG. 28 is a system level view of the quasi-sinusoidal variable capacitor, an inductive circuit, and a synchronous motor-generator set. Additionally, it illustrates the use of other components, such as an AC/DC converter, signal measuring and data processing equipment, vacuum and heat pumps, as well as a grounded vacuum chamber.

FIG. 29 is a macro-level view of a system of quasi-sinusoidal variable capacitors providing mechanical energy to a single synchronous generator from the electrical current of a single inductive circuit.

FIG. 30 is a partial isometric view of a coaxial embodiment of a quasi-sinusoidal variable capacitor illustrating its major elements.

FIG. 31 is a front view of the coaxial embodiment of FIG. 30, which illustrates important geometric features of its stator and rotor.

FIG. 32 is a table providing the enumeration schemes used within this disclosure's figures Particularly, it provides both a standard and unique scheme related to the hierarchy of the device's sub-assemblies and its notable elements.

### DETAILED DESCRIPTION OF THE INVENTION

The quasi-sinusoidal variable capacitor will be described in this section. This detailed description analyzes the device's mechanical and electrical characteristics. However, this section does not contain an exhaustive description of the device and should not be interpreted as a limitation of its construction, modes of operation, or its output.

The quasi-sinusoidal variable capacitor is comprised of three main components, a stator, a rotor, and an inductive circuit. The stator is a capacitive structure whose capacitance varies upon rotation of the rotor. The capacitive stator is electrically connected to the inductive circuit. This inductive circuit has a DC voltage source, inductance, and can have a resistive load depending on its mode of operation. The quasi-sinusoidal variable capacitor can operate as a generator (e.g., an alternator) with over-unity efficiency, a motor that does not require input energy during operation, and as both a generator and a motor simultaneously. When the quasi-sinusoidal variable capacitor is made to operate as a motor, it can be added to a synchronous motor-generator set. In this preferred mode, the quasi-sinusoidal variable capacitor adds to the mechanical energy being supplied to the generator by the motor.

The stator is comprised of three major elements, stator plates, stator connectors, and stator mounts. These major elements are combined into minor sub-assemblies, defined as stator poles. These stator poles have a small amount of self-capacitance as their stator plates are electrically connected to one another through their stator connectors. Additionally, mutual capacitance between the stator poles further increases the stator poles' capacitances. This mutual capacitance is dependent on the proximity of the stator poles to one another. The stator pole mounts are used to maintain a desired distance or gap between the stator poles.

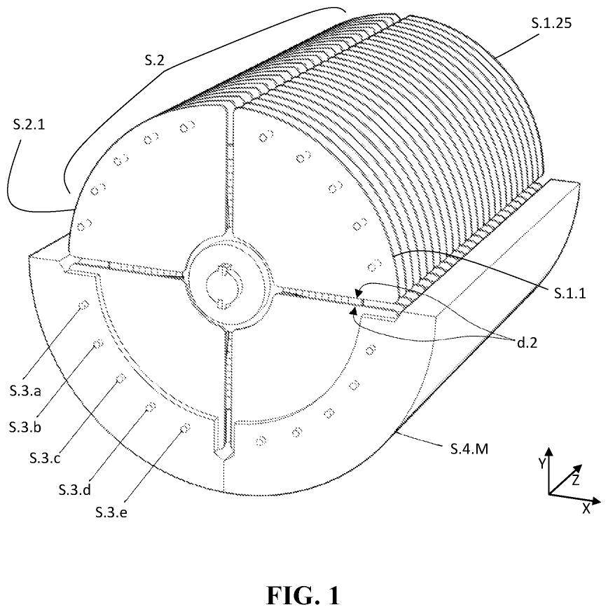

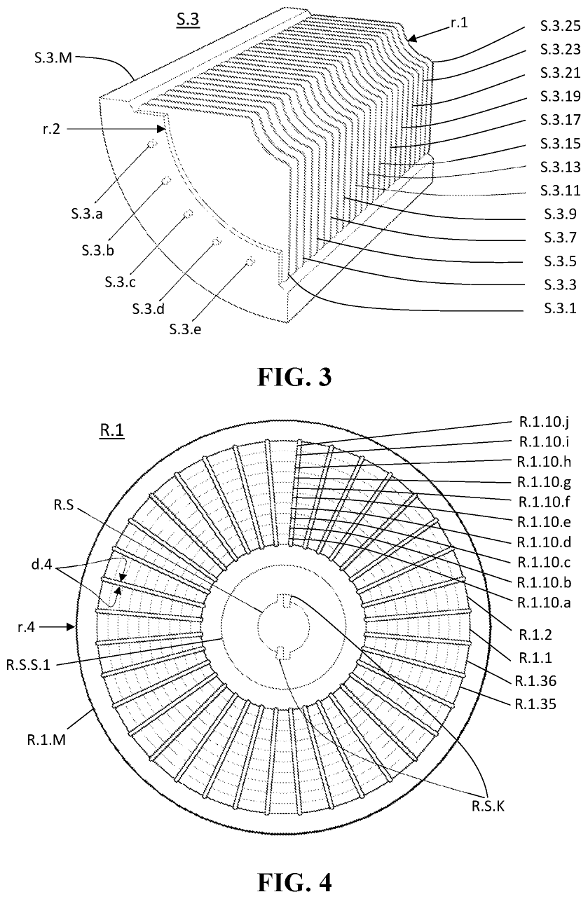

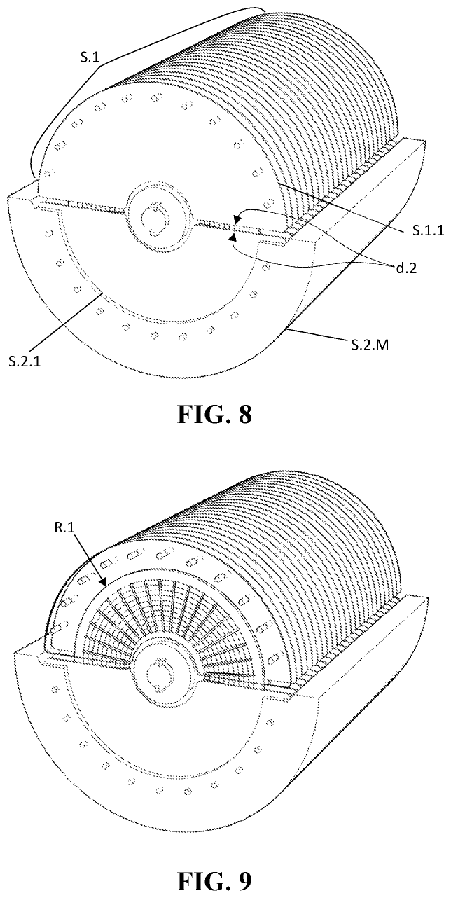

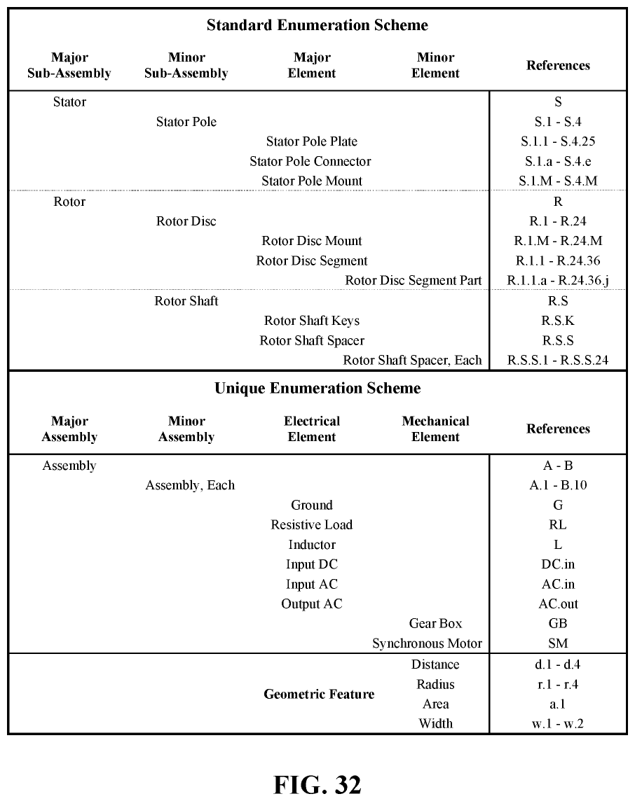

The capacitive stator is comprised of an even number of stator pole sub-assemblies. Turning to FIG. 1, the stator pole S.2 denotes this embodiment's second stator pole. Following the quadrants of the Cartesian coordinate system, the top right stator pole is S.1, the bottom left is S.3, and the bottom right is S.4. These three, and most other references in this disclosure's figures, are left unlabeled because a common enumeration scheme has been used throughout. A table defining this enumeration scheme is available in FIG. 32. Looking back at FIG. 1, the stator's poles are symmetric about the X and Y-axes. With this similarity, the stator poles are electrically connected in parallel with one another. The stator pole S.1 is electrically connected to S.3, and S.2 is electrically connected to S.4. These groupings host opposite charges within them during operation. When S.1 and S.3 are positively charged. S.2 and S.4 are negatively charged. FIG. 8 demonstrates a two-poled embodiment whose poles S.1 and S.2 are likewise symmetric. In either case, the stator poles are designed so they can be fabricated individually and then combined to form a major sub-assembly, the stator. The minor sub-assembly of FIG. 3 illustrates the major elements of an individual stator pole. S.3.

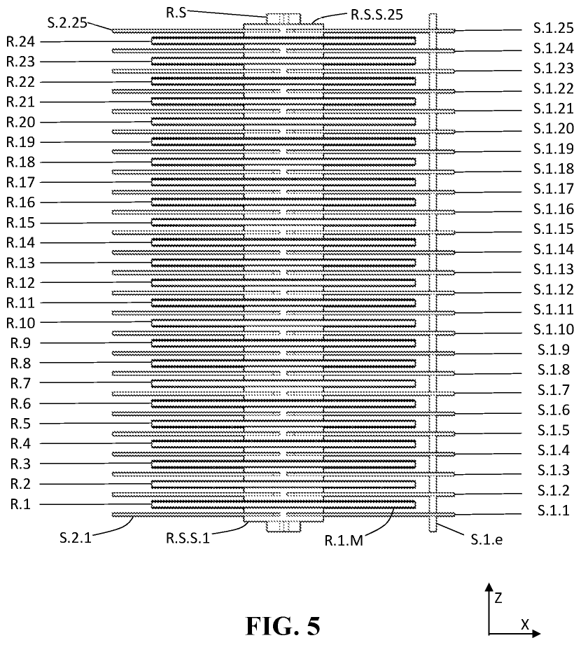

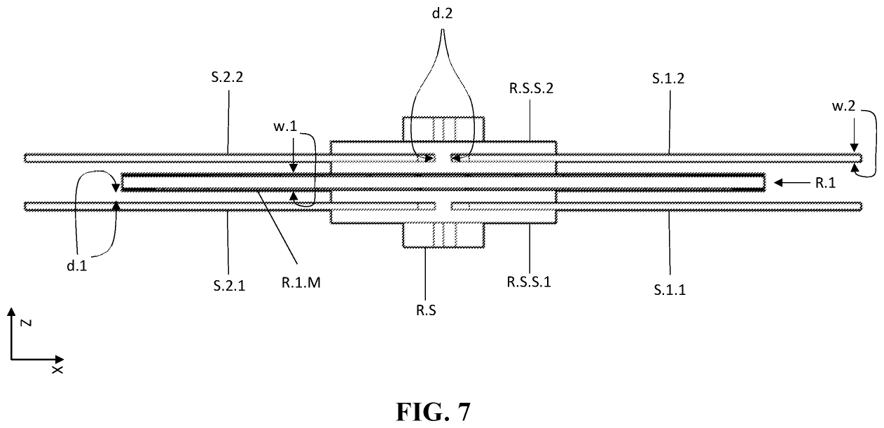

As shown in FIG. 3, the stator poles are further comprised of stator pole plates. These stator pole plates are made of a conductive material such as aluminum. In some embodiments, these stator pole plates are chemically etched to increase their surface area, and therefore their capacitance. FIG. 1 provides an isometric view of the stator pole plates. In this view S.1.1. S.1.25, and S.2.1 are specifically referenced. These stator pole plates are identical to one another as illustrated in FIG. 3. Here, the odd numbered stator pole plates, S.3.1-S.3.25, are referenced for S.3. FIG. 3 calls out the geometric feature radius r. 1, which is necessary to allow for the rotation of the rotor. FIG. 5 shows a partial top view of the embodiment of FIG. 1. In this view, the stator pole plates S.1.1-S.1.25, S.2.1, and S.2.25 are referenced. This partial top view illustrates that the stator pole plates are evenly spaced from one another as well as from the rotor discs R.1-R.24. More specifically, FIG. 7 identifies the distance d.1 between the stator pole plate S.2.1 and the rotor disc R.1. This distance d.1 exists between all stator pole plates and rotor discs. Likewise, FIG. 7 identifies the distance d.2 between the stator pole plates S.1.2 and S.2.2. This distance d.2 exists between all stator pole plates as is illustrated in FIG. 1 and FIG. 8.

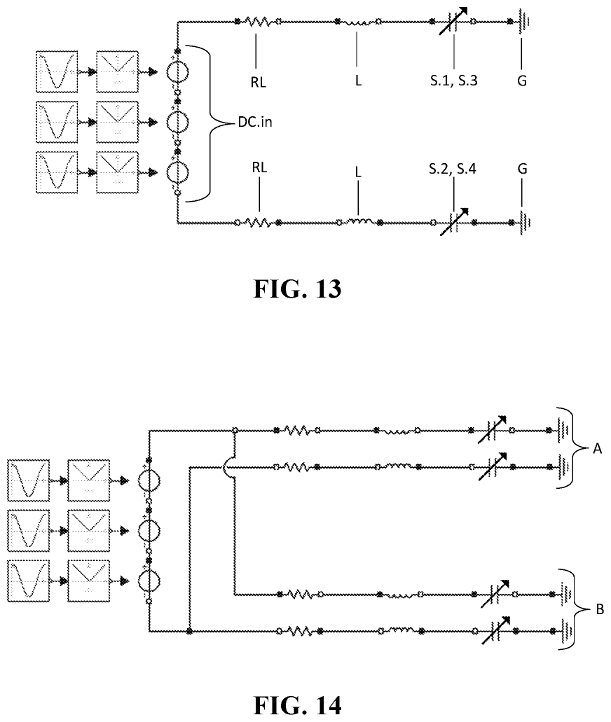

The stator pole plates of FIG. 1 and FIG. 3 are electrically connected by stator pole connectors. Here, the stator pole plates of stator pole S.3 are connected with the stator pole connectors S.3.a-S.3.e. These stator pole connectors are made of a conductive material such as aluminum. However, these stator pole connectors, for some embodiments, are required to keep the fixed placement of the stator pole plates. For these embodiments, at least one stator pole connector per stator pole would be made of a conductive material. The remaining stator pole connectors would be made of a sturdier material such as an aluminum alloy. The stator pole connectors are connected to an inductive circuit such as the equivalent circuit model of FIG. 13. Here, the stator poles S.1 and S.3 are represented in this equivalent circuit as a variable capacitor. Likewise, the stator poles S.2 and S.4 are represented as a second variable capacitor. The two sets of stator poles share singular connections to the circuit because they are electrically connected in parallel prior to being connected to the circuit. FIG. 5 presents a top view of a stator pole connector. In this drawing, S.1.e is present to show how the stator connectors provide electrical conductivity between the stator pole plates S.1.1-S.1.25.

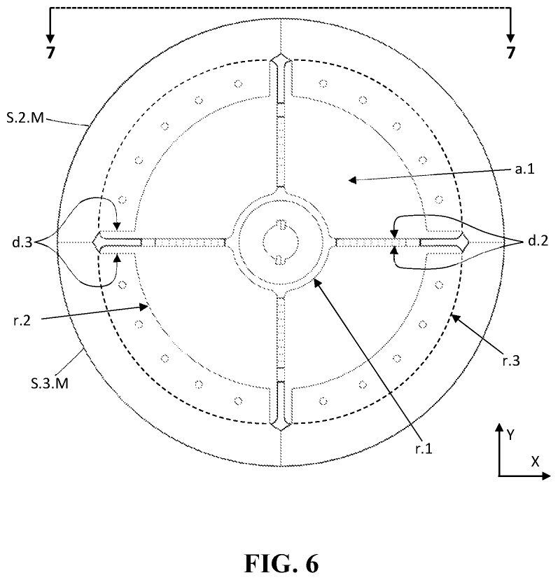

The stator pole connectors are not alone in their role of keeping the stator pole plates fixedly placed. The embodiment of FIG. 1 partially illustrates the implementation of stator mounts. Here, the stator mounts S.3.M and S.4.M are displayed, whereas the stator mounts S.1.M and S.2.M have been removed to better illustrate the stator poles S.1 and S.2. However, FIG. 6 offers a front view of the embodiment of FIG. 1 in which all stator mounts are present. The stator mounts of the embodiment of FIG. 1 are made of a non-conducting material such as uPVC. Due to the capacitive nature of this device, the stator mounts are not only used to keep the stator plates fixedly placed, but they are also used to electrically insulate the stator plates from undesirable mutual capacitance. FIG. 3 provides an additional view of the stator pole mount S.3.M. While not shown here, the stator pole mounts are slotted along the radius r.2 to keep the stator plates fixedly placed. However, for further clarity, FIG. 6 offers a front view of the embodiment of FIG. 1 where the stator plates' hidden lines within the stator mounts are denoted as r.3. Back to FIG. 3, the curved plane conveyed by the radius r.2 therefore resides between each of the stator pole plates. These slots in the stator mount restrict the movement of the stator plates along the Z-axis, whereas the stator connectors restrict the movement of the stator plates along the X and Y-axes. Due to the stator mounts' dielectric properties, they must be designed to avoid electrical breakdown within them. Referring again to FIG. 6, the stator mounts are designed with the distance d.3 to prevent the stator plates' large electrical fields from unnecessarily transferring through the dielectric stator mounts.

The quasi-sinusoidal variable capacitor has a stator whose capacitance varies due to the rotation of its rotor. This rotor is comprised of at least one rotor disc. Each rotor disc consists of rotor disc segments that are fixedly attached to a rotor mount. The rotor discs are attached to a rotor shaft, comprised of a shaft, keys, and spacers. In coplanar embodiments, the rotor discs are interleaved within the stator plates such that rotation of the rotor maintains the distance d.1 between the rotor and stator. The rotation of the rotor changes the position of the rotor disc segments relative to the gap, distance d.2, between the stator poles. This change in position varies the stator's capacitance.

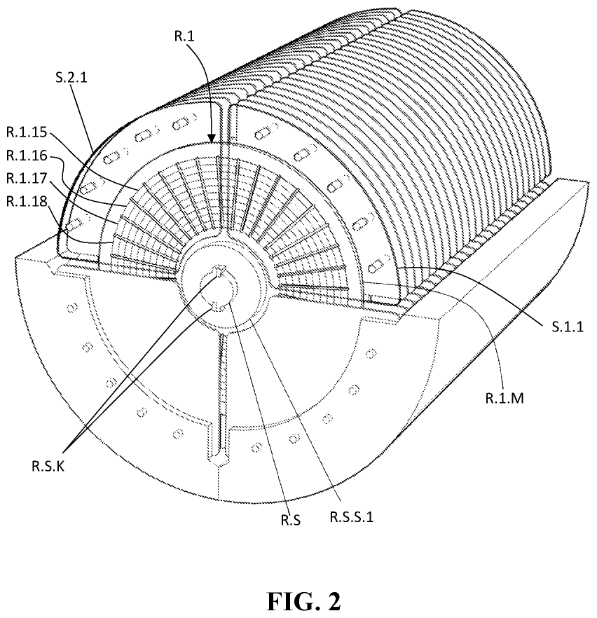

In coplanar embodiments, there is one less rotor disc than stator pole plates per pole. That is, when the device's stator has twenty-five stator pole plates per pole, then the rotor has twenty-four rotor discs. This arrangement maximizes the working area of the rotor discs as well as reduces the risk of injury from the rotating discs. Turning to FIG. 2, a partial isometric view of the rotor disc R.1 is displayed relative to the stator. Here, the stator pole plates S.1.1 and S.2.1 are transparent to show greater detail of the rotor. FIG. 4 provides a front view of the rotor disc R.1 and FIG. 5 illustrates the rotor discs' R.1-R.24 relative positions to the stator plates. FIG. 7 designates the distance d.1 between the rotor discs and stator plates, which is required to allow for unimpeded rotation of the rotor discs. Theoretically, d.1 should be as small as possible to provide the greatest variance in capacitance. However, the length of this distance needs to be large enough for the rotor discs' displacement tolerances during rotation. A slight wobble of the rotor discs during rotation will periodically reduce this distance.

The rotor discs' displacement tolerances are dependent on the rotor disc mounts material properties. The device's rotor mounts can be constructed of a non-conductive rigid material such as uPVC or carbon fiber. The width w.1 of the rotor mount R.1.M of FIG. 7 is dependent on the radii of the rotor discs and the mechanical properties of the rotor mount's materials. In some embodiments, the rotor segments are fixedly attached to the rotor mount, such as with uPVC. Whereas in other embodiments the rotor segments are embedded within the rotor mount's composite material. FIG. 2 designates the rotor mount R.1.M of the rotor disc R.1 relative to the stator and FIG. 4 displays a front view of R.1's rotor mount, R.1.M. In this view, the outlines of the rotor shaft R.S and rotor shaft keys R.S.K represent where these elements traverse through the rotor mount. This traversal of the rotor shaft R.S through the rotor mount R.1.M can be inferred from FIG. 7. The rotor mount transfers the rotor's mechanical energy, induced within the rotor segments, to the rotor shaft.

Mechanical energy is established within the rotor segments due to electrostatic induction within them. This electrostatic induction within the rotor segments is induced from the electric charge stored within the stator's capacitance. This mechanical energy is the result of the induced electrical dipoles within the rotor segments being forcibly attracted to the stator's electrical charge. The amount of electrostatic induction within the rotor segments is dependent on the amount of charge stored within the stator's capacitance, the size of the rotor segments, the position of the rotor segments relative to the gap between the stator poles, and the conductivity of the rotor segments. Therefore, the rotor segments and the gap, distance d.2, must be designed to ensure that a quasi-sinusoidal variance in the stator's capacitance is formed with the electrostatic induction within the rotor segments. In order to maximize this electrostatic induction, the rotor discs' rotor segments are constructed of a conductive material such as aluminum. However, the rotor segments can alternatively be constructed from a non-conducting or semi-conducting material with a higher electrical permittivity than that which is between the rotor segments, distance d.4 in FIG. 4. In some embodiments, these rotor segments are chemically etched to increase their surface area, and therefore their electrostatic inductance. FIG. 2 references the rotor segments R.1.15-R.1.18 relative to the rotor disc R.1 and the stator sub-assembly. FIG. 4 references the rotor segments R.1.1. R.1.2, R.1.35, and R.1.36. This front view of the rotor segments illustrates how they are identical to each other and equally spaced around the rotor mount. The four-poled embodiment of FIG. 2 employs thirty-six rotor segments to vary the stator's capacitance quasi-sinusoidally, every 10-degrees of the rotor's rotation. Notably, the two-poled embodiment of FIG. 9 employs the thirty-six rotor segments of R.1. This is a result of the number of rotor segments n_{Seg}, having to be divisible by the number of stator poles.

The device's rotor segments, as specified in FIG. 4, are further divided into rotor segment parts, such as the rotor segment parts R.1.10.a-R.1.10.j. These individual rotor segment parts are laminated together in the same manner as transformer cores to reduce undesirable eddy currents within the rotor segments. Currents from electrostatic induction are desirable, but eddy currents caused by electromagnetic induction are not. FIG. 4 illustrates a method for fabricating rotor segment parts where ten individual conductive rings, a-j, are laminated together and embedded within the rotor mount. A waterjet cutter is then used to cut thirty-six slots of distance d.4 into both the rotor mounts and the conductive rings simultaneously. This method establishes thirty-six rotor segments, each with ten rotor segment parts.

The slots of distance d.4 are not required to achieve a quasi-sinusoidal variance in capacitance but are often useful. For instance, when the thickness of the rotor mount w.1 is too thick and its relative electrical permittivity too high, the stator's variance in capacitance tends more towards sinusoidal rather than quasi-sinusoidal. These slots of distance d.4 are useful at reducing the electrical permittivity between the rotor segments. These slots also support a larger output of the quasi-sinusoidal variable capacitor. They increase the electrical breakdown strength between the rotor segments to that of the vacuum within the vacuum chamber in which the device resides. The maximum output of the quasi-sinusoidal variable capacitor is dependent on the maximum breakdown strength of its materials and its geometric design with respect to its stator's charge and its rotor segments' induced charges.

The rotor's induced mechanical energy is transferred from the rotor to an external user through a rotor shaft. The rotor shaft R.S is referenced in FIG. 2 and FIG. 4 and is shown to reside through the entirety of the rotor sub-assembly in FIG. 5 and FIG. 7. The rotor shaft employs the use of rotor shaft keys R.S.K as referenced in FIG. 2 and FIG. 4. Here, the rotor shaft and rotor shaft keys are shown to be slightly abnormal compared to their standard counterparts. This slight deviation is required to make use of the rotor shaft spacers R.S.S.1-R.S.S.25, as illustrated in FIG. 5. Additionally, the rotor shaft spacers R.S.S.1 and R.S.S.2 of FIG. 7 show the size and positions of the rotor shaft spacers relative to the rotor discs and stator plates. These rotor shaft spacers are but one mechanism possible for keeping the rotor discs fixedly located along the Z-axis relative to the stator plates. For this reason, the exact design of the rotor's shaft, keys and spacers are immaterial to this disclosure.

This invention utilizes a quasi-sinusoidal variance in its stator's capacitance to produce a larger amount of energy than it consumes. The stator's capacitance will be evaluated in this disclosure as the sum of its fixed and variable capacitances. From this evaluation the formation and implementation of its quasi-sinusoidal variance in its capacitance will be addressed. The importance of a quasi-sinusoidal variance in the stator capacitance's waveform stems from the effect it has on the rotor's torque proportionality, which is equal to the rotor's torque divided by the square of the stator's charge.

The stator's fixed capacitance is dependent on the mutual capacitance between the stator poles. This mutual capacitance is proportional to the area, denoted by the width w.2 of the stator pole plates and the length r.3 minus r. 1, divided by the distance d.2 between the stator pole plates, as represented in FIG. 7 and FIG. 6, respectively. Additionally, the stator's fixed capacitance is proportional to its self-capacitance and its mutual capacitance between the stator pole plates and the device's other components (e.g., its vacuum chamber). The outside facing surface areas, as referenced by a.1 in FIG. 6, of the stator plates S.1.1-S.4.1 and S.1.25-S.4.25 have greater exposure to undesirable electrostatic induction than the rest of the stator plates' surfaces. The stator mounts S.1.M-S.4.M must be designed to reduce the stator's mutual capacitance with the device's other components. While the stator's capacitance is embodiment dependent, it can be stated as C(θ)=C_{fixed}+C_{variable}(θ); whereas C_{variable}(θ) is equal to the stator's variance in capacitance per the rotor's rotation angle θ.

The amplitude of the stator's variance in capacitance is proportional to the ratio between the distances d.2 and d.1. This variance increases as d.1 decreases. The embodiment of FIG. 1 maintains a larger than ideal distance d.1 between the rotor and the stator relative to the distance d.2. This enlarged distance d.1 was chosen to provide greater visual clarity within this disclosure's figures. The stator's variance in capacitance is dependent on the radius r.4 of the rotor discs, as referenced in FIG. 4. This is because the areas of the rotor disc segments increase as the radii of the rotor discs increase. Additionally, the areas of the rotor disc segments increase as the number of rotor segments n_{Seg} decreases while the distance d.4 is unchanged. This increase in the rotor segments' surface areas establishes a larger peak to peak variance in the stator's capacitance. However, as indicated by equation (1), the difference between the stator's maximum and minimum capacitance is less important than the rate of change of the stator's capacitance with respect to the rotor's angle of rotation.

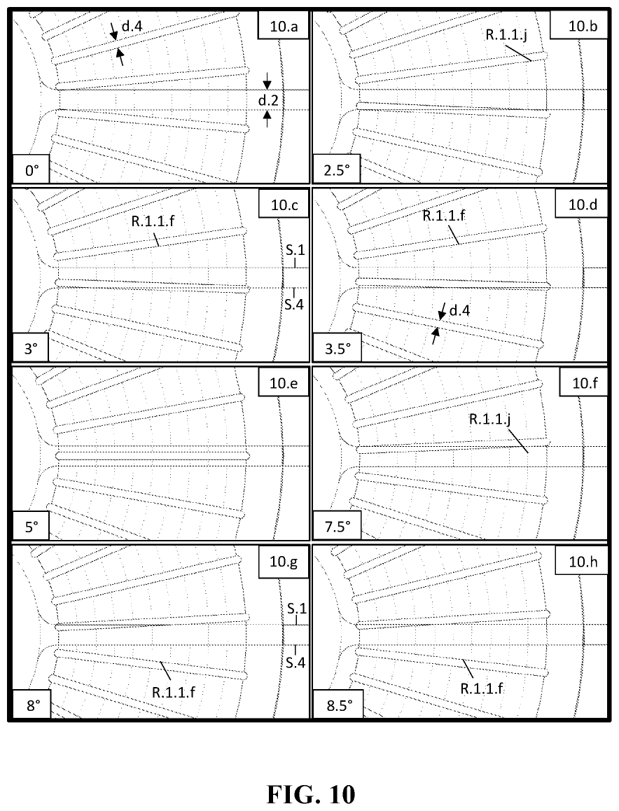

The waveform of the stator's variance in capacitance is determined by the relative proximity of the rotor segments to the distance d.2 between the stator pole plates, as illustrated in FIG. 10. Here, the stator's capacitance is at a maximum, at 0-degrees, when the overlap between the rotor segments and the stator pole plates is at a maximum, as shown in FIG. 10.a. The stator's capacitance is at a minimum, at 5-degrees, when the distance d.4 is squarely between the stator pole plates, as shown in FIG. 10.e. These maximum and minimum capacitances represent the zeroth and second quarters of the stator's variance in capacitance, respectively. The waveform's first and third quarters, its medians, are illustrated in FIG. 10.b and FIG. 10.f, respectively. Here, FIG. 10.b illustrates the maximum rate of decrease in the stator's capacitance and FIG. 10.f illustrates the maximum rate of increase. These maximum rates of change in the stator's capacitance occur at these angles, 2.5 and 7.5-degrees, because the rotor disc segment part R.1.1.j is exiting and entering its neighboring stator pole plates. When the stator pole plates, as well as the rotor disc segments are symmetric, the maximum rate of change in capacitance is equal at these two angles.

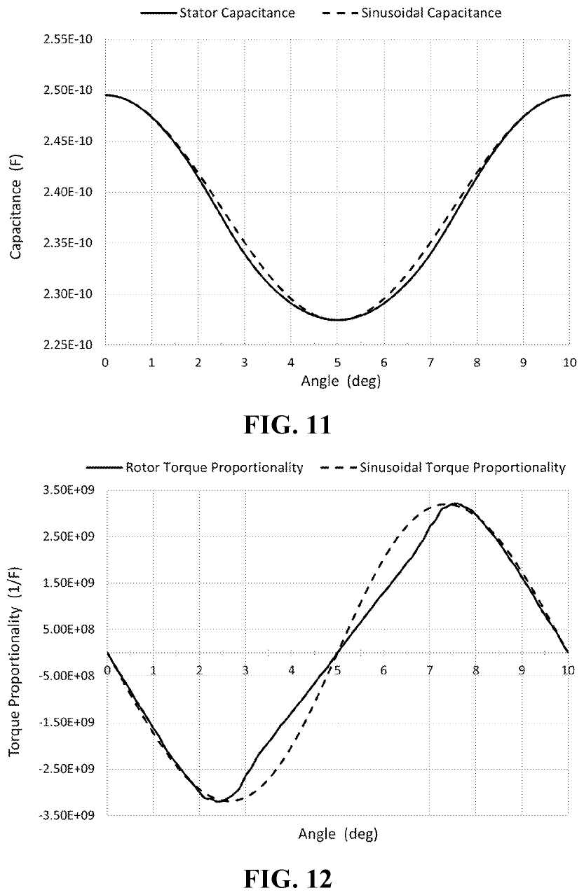

These geometric properties occur for both sinusoidal and quasi-sinusoidal variances in the stator's capacitance. However, these two waveforms differ in that a quasi-sinusoidal variance's rate of change in capacitance on either side of its waveform's medians, 2.5 and 7.5-degrees, are unequal. Graphically this is shown in FIG. 11, where there is a distinguishable difference in the rate of change of the stator's capacitance and that of a sinusoidal capacitance at 3-degrees. However, the difference between these two rates of change is shown to be much smaller at 8-degrees. Geometrically this is shown by the difference in the rates of change in the overlap of the rotor segments and stator pole plates between FIG. 10.c and FIG. 10.g. Specifically, the rotor segment part R.1.1.f of FIG. 10.g is shown to be entering the top right stator pole S.1 at 8-degrees, as the rotor is rotating counterclockwise. Whereas the rotor segment part R.1.1.f of FIG. 10.c is shown to not be exiting S.4 at 3-degrees. Therefore, the rate of change in the electrostatic induction within the rotor segment part R.1.1.f in FIG. 10.g is larger than that in FIG. 10.c. Comparing FIG. 10.g to FIG. 10.h, an increase in electrostatic induction was formed between 8 and 8.5-degrees of the rotor's rotation. Comparing FIG. 10.c to FIG. 10.d, a smaller reduction in electrostatic induction occurs due to the absence of conductive material within the distance d.4. FIG. 10 illustrates how the position of the rotor, relative to the stator, establishes the quasi-sinusoidal variance in the stator's capacitance of FIG. 11 due to the variance in the electrostatic induction within the rotor.

In general, the device's rotor and stator design rely on the rate of change in electrostatic induction within the rotor. Careful consideration must be given to the width w.1, and distance d.4, of the rotor mount. Likewise, elements of the rotor, such as its rotor shaft and rotor shaft keys, will induce a small variance in capacitance. These types of variances are undesirable, as they will not occur equally for each of the rotor segments. For example, FIG. 4 indicates that the variance in capacitance between angles θ and 10-degrees differs slightly from that between 40 and 50-degrees, due to the orientation of the rotor shaft keys. These slight variances in capacitance are embodiment dependent and thus will not be covered in greater detail within this disclosure.

The capacitance of a quasi-sinusoidal variable capacitor is varied by the rotation of its rotor. When there is no charge held within the device's capacitance, the amount of torque required to maintain rotation of its rotor is proportional to the friction between its rotor shaft and its bearings, and the wind resistance across the surfaces of its rotor discs. However, when there is a fixed electrical charge Q_{Fixed} within the stator's capacitance, additional torque must be applied to rotate the rotor while the stator's capacitance is decreasing. This additional torque is required because decreasing the stator's capacitance increases the potential energy stored within it. The amount of work required to decrease the stator's capacitance is equal to the increase in potential energy stored within its capacitance. Likewise, an equal amount of torque is acquired when the stator's capacitance is increasing. Therefore, over one rotation, the rotor experiences equal negative and positive amounts of torque as the relative position of the rotor segments change.

The time-dependent change in capacitance will vary the strength of the electric fields within it. These changing fields induce a small amount of magnetic field resistance. However, this magnetic field resistance is small relative to the rotor's friction due to the quasi-electrostatic nature of this device. A quasi-electrostatic field is an electric field whose amplitude is much larger than the amplitude of its induced magnetic field. This device has quasi-electrostatic fields because the rate of change of its electric fields is sufficiently low, and its materials are specifically chosen for their low relative permeabilities. Therefore, the torque required to maintain rotation of the rotor, when the stator's charge is fixed, is equal to the resistive torque associated with the rotor's friction and the resistance imposed by the induced magnetic field.

The rotor's torque, as approximated by equation (1), is proportional to the amount of charge stored within the stator's capacitance per angle of rotation. The rotor's torque proportionality τₚᵣₒₚ(θ), is equal to:

$${τ}_{prop} ( θ ) = \frac{{τ}_{Rotor} ( θ )}{{( {Q}_{Fixed} )}^{2}} . \qquad ( 2 )$$

Considering equation (1), the rotor's torque proportionality is approximately equal to:

$${τ}_{prop} ( θ ) ≅ \frac{{α}_{Fit}}{2} \frac{\frac{d}{d θ} C ( θ )}{{C ( θ )}^{2}} . \qquad ( 3 )$$

The rotor's torque proportionality for the stator's capacitance of FIG. 11 is displayed in FIG. 12. This plot displays a torque proportionality of the sinusoidal waveform as a reference. FIG. 12 demonstrates that the absolute value of the rotor's torque proportionality at 3.5-degrees is substantially less than that at 8.5-degrees. This plot illustrates that the geometrical differences between FIG. 10.d and FIG. 10.h establish unequal torque proportionalities at these two angles. It is also possible to have a torque proportionality at 3.5-degrees whose absolute value is greater than that at 8.5-degrees. For a device to have a quasi-sinusoidal variance, its corresponding torque proportionalities at these two angles (relative to the number of rotor segments) must not be equal to those of the sinusoidal variance. The amplitude of the rotor's torque proportionality of FIG. 12 is dependent on both the size of the stator's capacitance and the rate of change in its variance, as indicated by equation (3).

A constant charge held within the stator's capacitance establishes an alternating torque within the rotor that is proportional to the rate of change in the stator's capacitance. When the stator's capacitance is supplied with a constant DC voltage V_{dc}, rotation of the rotor additionally induces an alternating current back into the voltage source. Similar to the fact that an alternating torque, with equal amplitudes, yields a net of zero restriction to rotation, this alternating current yields a net of zero electrical loss within the DC voltage source. Similar to the resistances due to friction, there are electrical losses associated with this current flowing through the circuit's electrical resistances, including the internal resistance of the DC voltage source. This alternating current induces a magnetic field within the stator which imposes additional resistance to rotation. The amount of torque required to maintain rotation of the rotor, under constant voltage, is proportional to its mechanical, magnetic and circuit's electrical resistances.

The device's equivalent RLC circuit is displayed in FIG. 13. This simplified circuit comprises a DC voltage source DC.in, resistive loads RL, inductors L, the variable capacitances of the stator poles S.1-S.4, and grounds G. The grounds in this case represent the grounded vacuum chamber, which is grounded to reduce the risk of electrical shock. This risk stems from the vacuum chamber's undesirable mutual capacitance with the stator. As previously stated, the stator poles S.1-S.4 share a mutual capacitance with one another which is illustrated in FIG. 6. Furthermore, the circuit's resistive loads RL in FIG. 13 represent the sum of all the circuit's electrical resistances in order to provide a simplified illustration of the device's RLC circuit. Therefore, the circuit's usable electrical load is denoted as R_{load}, however, the circuit's internal resistances remain unnamed. The circuit's combined internal resistances are embodiment dependent but are equal to 15-Ohms for all variations of the device within this disclosure.

The RLC circuit of FIG. 13 utilizes a DC voltage source but the stator's variance in capacitance induces an alternating current. This DC voltage source must not impede the alternating current's flow. The DC voltage source DC.in of FIG. 13 represents a 3-pole DC generator with a voltage V(t) equal to:

$$V ( t ) = {\sum }_{i = - 1}^{1} \vert \frac{π}{6} {V}_{dc} cos ( \frac{{ω}_{Cir}}{3} t - ( i \frac{π}{3} + {ϕ}_{dc} ) ) \vert . \qquad ( 4 )$$

Here, ω_{cir} is the angular frequency of the circuit's current, and ϕ_{dc} is the generator's phase angle relative to the rotor's rotation angle per rotor segment. It is possible to use an AC voltage source with the quasi-sinusoidal variable capacitor, however, a DC voltage source is preferred. This preferred embodiment's circuit inductance establishes an inductive circuit, rather than a capacitive or resonant circuit. The circuit's inductance is equal to

$$L = \frac{{α}_{resonance} {α}_{inductance}}{{( {ω}_{Cir} )}^{2} {C}_{mean}} ;$$

whereas α_{resonance} is a multiplier which brings the circuit into resonance and the multiplier α_{inductance} increases the circuit's inductance. Cₘₑₐₙ is the stator's mean capacitance. In this disclosure, the values

$$\frac{{α}_{resonance}}{{( {ω}_{Cir} )}^{2} {C}_{mean}}$$

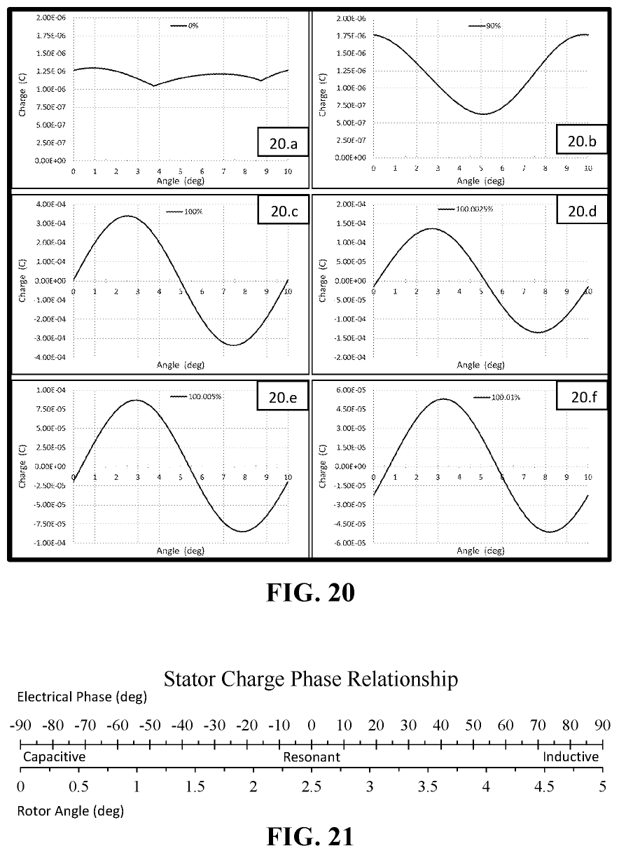

are fixed, whereas the value α_{inductance} is changed per variation to further describe the device's electromechanical characteristics. This inductive circuit produces a lagging current. This current, in terms of the quasi-sinusoidal variable capacitor, is related to the comparison of the current's phase and the stator's variance in capacitance, rather than the circuit's voltage. As illustrated in FIG. 20.c and FIG. 21, the circuit's current is in resonance when its stator charge's peak is in phase with the stator's maximum rate of change in capacitance.

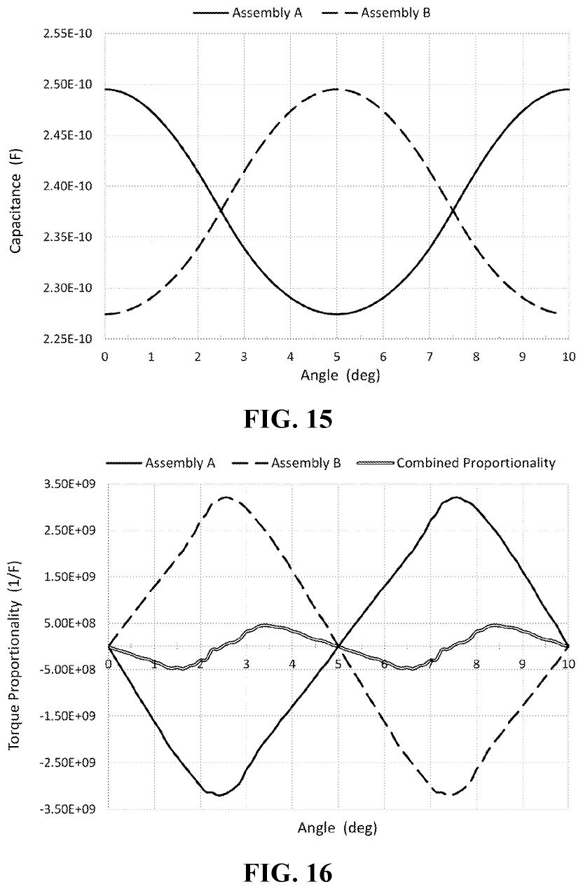

The large negative and positive torque associated with the variance in the stator's capacitance of FIG. 12 and FIG. 11, respectively, cause an undesirable amount of mechanical vibration during operation. To help alleviate this, two assemblies, denoted as A and B in FIG. 14, are combined to share a single rotor shaft, R.S. FIG. 15 illustrates how the capacitance of assembly B is out of phase with assembly A by one-half of their wavelengths. Consequently, assembly B's capacitance is increasing as assembly A's capacitance is decreasing. FIG. 16 then illustrates the two assemblies' torque proportionalities as well as their combined torque proportionality. Here, the waveform of the combined torque proportionality is shown to have a peak to peak that is 14.6% that of the individual assemblies. It also illustrates how a lagging current can establish a net positive amount of torque onto the rotor.

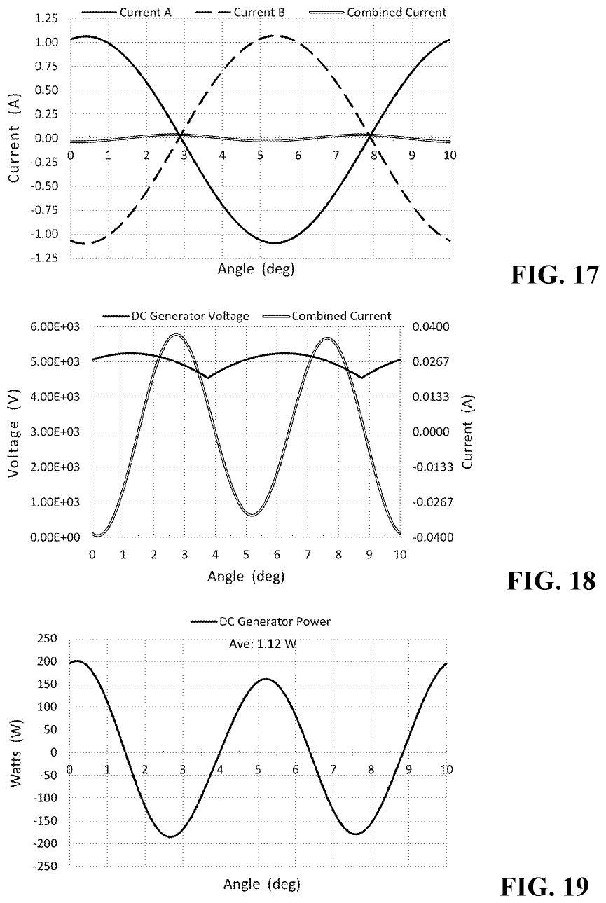

The combined assemblies of FIG. 14 reduce the amount of current flowing through their shared DC voltage source. Turning to FIG. 17, assembly A's current is combined with that of assembly B to form a combined current. Here, these currents represent a snapshot, per rotor segment, during steady state. When the rotor discs have thirty-six rotor segments, the variances in capacitances of FIG. 15 repeat themselves every 10-degrees. The waveforms of the currents of FIG. 17 likewise repeat themselves during steady state operation. The circuit of FIG. 14 abides by Kirchhoff's circuit laws in that the combined current of FIG. 17 is the sum of each of the branch's individual currents. The current of each branch is calculated by solving for

$$\frac{d}{dt} {Q}_{\#} ( t )$$

from the equation:

$$V ( t ) = {L}_{\#} \frac{{d}^{2}}{{dt}^{2}} {Q}_{\#} ( t ) + R {L}_{\#} \frac{d}{dt} {Q}_{\#} ( t ) + \frac{{Q}_{\#} ( t )}{{C}_{\#} ( {θ}_{t} )} , \qquad ( 5 )$$

whereas #represents assembly A or B. The combined current,

$$\frac{d}{dt} Q ( t ) = \frac{d}{dt} {Q}_{A} ( t ) + \frac{d}{dt} {Q}_{B} ( t ) ,$$

flowing through the DC voltage source is then found by solving for it from the equation:

$$V ( t ) = {L}_{A} \frac{{d}^{2}}{{dt}^{2}} {Q}_{A} ( t ) + R {L}_{A} \frac{d}{dt} {Q}_{A} ( t ) + \frac{{Q}_{A} ( t )}{{C}_{A} ( {θ}_{t} )} + {L}_{B} \frac{{d}^{2}}{{dt}^{2}} {Q}_{B} ( t ) + R {L}_{B} \frac{d}{dt} {Q}_{B} ( t ) + \frac{{Q}_{B} ( t )}{{C}_{B} ( {θ}_{t} )} ; \qquad ( 6 )$$

wherein the values of L_{A}≡L_{B} and RL_{A}≡RL_{B} but are not equal in terms of solving the ODE.

The alternating combined current from equation (6) is established by the DC voltage source and the variances in the stators' capacitances, which is then amplified by the circuits' inductances but reduced by the circuits' electrical resistances. To do so, the DC voltage source DC.in must supply an initial amount of current to provide charge to the capacitive stators. Then, it must supply additional current that is proportional to the inductors' amplification. However, because the DC voltage source is not responsible for alternating the circuit's current, it no longer supplies current to the circuit during steady state, it only supplies its DC voltage. Illustrated in FIG. 18, the DC generator voltage V (t) is plotted alongside the combined current

$$\frac{d}{dt} Q ( t ) .$$

Specifically, the generator's phase ϕ_{dc} is illustrated to be offset by 1.25-degrees. This offset ensures that a small amount of power is supplied back to the DC generator as illustrated in FIG. 19. It is shown here that this offset yields an average 1.12 Watts being supplied back to the DC generator from the inductive circuit. The combined alternating current flowing through the DC voltage generator is not induced by the generator directly. By changing the generator's phase, the energy it receives from the circuit can be maximized. If the generator's phase ϕ_{dc} were instead −1.25-degrees, then the generator would be required to provide a small amount of energy to the circuit throughout steady state operation.

The DC voltage and combined current of FIG. 18 have opposite signs and as a result would not typically produce the output of FIG. 19. This discrepancy arises from equation (5), which enables a positive DC voltage to establish a positive charge within the capacitor of a purely capacitive circuit,

$$V ( t ) = \frac{{Q}_{\#} ( t )}{{C}_{\#} ( {θ}_{t} )} .$$

This method was used because it accurately reflects the equipotential characteristics of a purely capacitive circuit. The output of FIG. 19 can be derived in terms of a purely resistive circuit,

$$V ( t ) = {R}_{{load}_{\#}} \frac{d}{dt} {Q}_{\#} ( t ) .$$

Wherein V(t) is subtracted from both sides, followed by the multiplication of

$$\frac{d}{dt} {Q}_{\#} ( t ) .$$

This yields,

$${{R}_{{load}_{\#}} ( \frac{d}{dt} {Q}_{\#} ( t ) )}^{2} - V ( t ) \frac{d}{dt} {Q}_{\#} ( t ) = 0 ,$$

which states, the sum of a purely resistive circuit's input and output powers are zero. Therefore, the power flowing through the DC voltage generator is equal to:

$${P}_{dc} ( t ) = - V ( t ) \frac{d}{dt} Q ( t ) . \qquad ( 7 )$$

FIG. 20 illustrates the stator's charge for six variations of the equivalent circuit of FIG. 13. FIG. 20.a is the waveform of a capacitive circuit that has an R_{load} of 50-Ohms and 15-Ohms of internal electrical resistance (thus, RL=65-Ohms). This plot illustrates that the charge on the stator is pulsing, and its derivative is that of an alternating current. FIG. 20.b illustrates how an inductor that is ninety percent α_{inductance}=0.9 that of the circuit's resonant inductance, transforms the alternating current of FIG. 20.a to one that is more sinusoidal in form. When α_{inductance}=1, the inductance brings the circuit into electrical resonance, as is illustrated in FIG. 20.c. Here, the peaks of the resonant current's alternating charge occur at 2.5 and 7.5-degrees. In comparing FIG. 20.b and FIG. 20.c, a negative charge accumulates within the stator's capacitance as the circuit's inductance increases. As this inductance increases further, the amplitude of the positive charge becomes greater than that of the negative charge as indicated in FIG. 20.f. Despite this increasing positive offset of the stator's charge, the quasi-sinusoidal variable capacitor benefits from a lagging current. The additional plots within FIG. 20 provide the stator charges of three variations for the inductive circuit of FIG. 13. The stator charges displayed in FIG. 20.d-FIG. 20.f have inductances wherein α_{inductance} is equal to 1.000025, 1.00005, and 1.0001, respectively. The line graphs in FIG. 21 relate the current's electrical phase to the rotor's angle of rotation, per rotor segment while highlighting the circuit's capacitive-inductive spectrum.

A variance in capacitance establishes an alternating current in an inductive circuit. As a result, a quasi-sinusoidal variable capacitor, paired with an inductive circuit, can create energy. The quasi-sinusoidal variable capacitor's circuit is provided with the DC voltage of equation (4). Upon rotation of the rotor, the combined current

$$\frac{d}{dt} Q ( t ) ,$$

flows through the DC voltage source, providing power back to it as described by equation (7). Depending on the device's mode of operation, the assemblies' currents can flow through electrical loads R_{load}_{_{#}} providing electrical power to them, equal to:

$${P}_{{load}_{\#}} ( t ) = {{R}_{{load}_{\#}} ( \frac{d}{dt} {Q}_{\#} ( t ) )}^{2} . \qquad ( 8 )$$

This device has three modes of operation: as a generator, a motor, and as both a generator and a motor simultaneously. The electrical power of equation (8) is zero when the device is operating as only a motor, the second mode. This device can operate as a motor when a lagging current provides a positive average amount of torque to the rotor. Regardless of the mode of operation, the mechanical power required, or produced, during operation is equal to:

$${P}_{m e c {h}_{\#}} ( t ) = ( \frac{{ω}_{Cir}}{{n}_{Seg}} ) ( {τ}_{p r o {p}_{\#}} ( {θ}_{t} ) {{Q}_{\#} ( t )}^{2} ) . \qquad ( 9 )$$

It can be useful to write out the τₚᵣₒₚ_{_{#}}(θₜ) of equation (9) in the form of equation (3) in order to see how the rate of change in the stator's capacitance effects the mechanical input or output of the device as:

$${P}_{m e c {h}_{\#}} ( t ) ≅ ( \frac{{ω}_{Cir}}{{n}_{Seg}} ) \frac{1}{2} \frac{{{Q}_{\#} ( t )}^{2}}{{C}_{\#} ( {θ}_{t} )} \frac{\frac{d}{d θ} {C}_{\#} ( {θ}_{t} )}{{C}_{\#} ( {θ}_{t} )} {α}_{F i t} . \qquad ( 10 )$$

The potential energy stored within the stator's capacitance does work onto the rotor at a rate equal to

$$\frac{{ω}_{Cir}}{{n}_{Seg}} ,$$

by an amount proportional to the rate of change in the stator's capacitance.

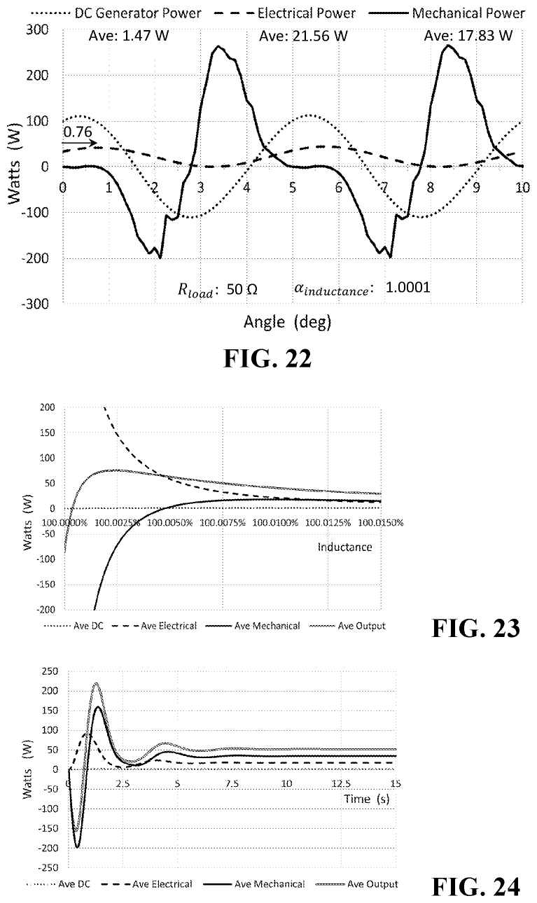

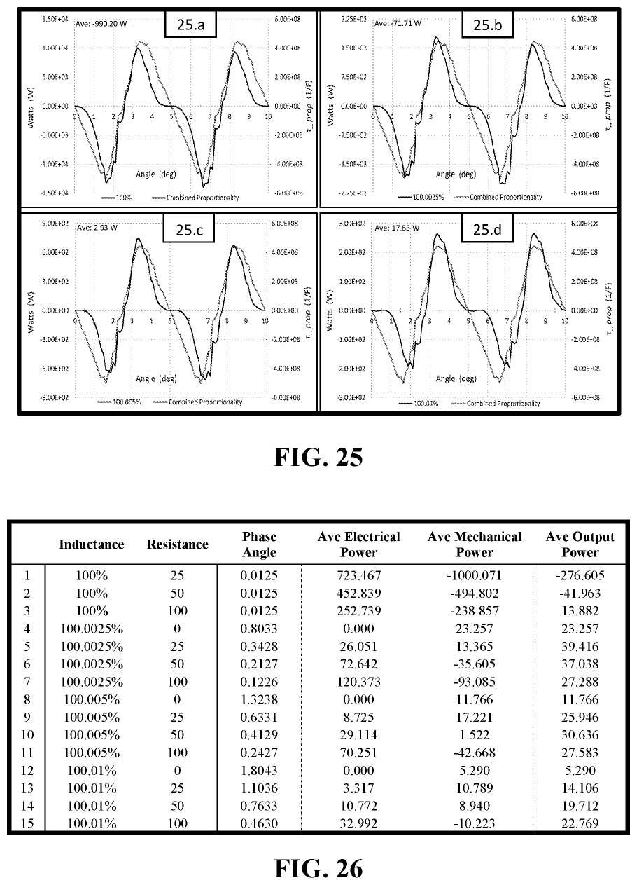

Equations (7-9) describe the inputs and outputs of the quasi-sinusoidal variable capacitor. Plots of these instantaneous values, and their averages, are displayed in FIG. 22 for one of the design's variations. Here, the combined current flowing through the DC voltage generator is alternating, but slightly offset. The sum of the electrical power produced within the device's two electrical loads illustrates how the stator's current is lagging by 0.76-degrees. This lagging current is shown to produce an alternating, but offset, mechanical output onto the rotor. The combined instantaneous mechanical power at 2-degrees is roughly negative 200 Watts. Alternatively, it is roughly 250 Watts at 3.5-degrees, leading to a positive average mechanical output of 17.83 Watts. Compare this mechanical output to the combined torque proportionality of FIG. 16, as is illustrated in FIG. 25.d. Then compare these to the stator charge plot of FIG. 20.f. With these comparisons, one can better comprehend how the mechanical output of FIG. 22 is possible.

The mechanical power's positive offset is caused by the electric field's ability to do work onto the rotor. The smaller negative mechanical output spikes of FIG. 22 are present because less work is required to slowly decrease the stator's capacitance. The larger positive spikes are present because the electric fields do more work onto the rotor as it quickly increases the stator's capacitance. Therefore, the mechanical output of FIG. 22 is only possible because of the quasi-sinusoidal variance in the stator's capacitance. Energy can be created when an alternating stator charge's peak occurs while the stator's capacitance is slowly decreasing, and while its other peak occurs when the stator's capacitance is quickly increasing (compare FIG. 10-FIG. 12 at 3.5 and 8.5-degrees as a reference). In terms of the quasi-sinusoidal variable capacitor, as described within this disclosure, this is possible when the stator's current is lagging due to the implementation of an inductive circuit.

To illustrate this point further, FIG. 23 displays the average outputs of equations (7-9) per α_{inductance}, between resonance, 100%, and an over inductance of 100.015%. Additionally, FIG. 23 displays the sum of the average outputs of equations (7-9). This summation of outputs, Ave Output, displays the average amount of energy either being created or destroyed depending on the value of α_{inductance}. This Ave Output plot dictates that energy is not conserved. If it was conserved, this plot would be equal to the energy lost in the circuit's internal resistance of 15-Ohms for all values of α_{inductance} (hence, the Ave Output could not be positive). FIG. 23 illustrates that the law of conservation of work can be taken advantage of to create energy with a quasi-sinusoidal variable capacitor and a lagging current. Energy cannot be conserved since mechanical work is required to induce a lagging current, and a lagging current produces a positive average amount of mechanical work. The quasi-sinusoidal variable capacitor can have a positive average mechanical output only because the work done by the electric field is conserved.

The average mechanical outputs of FIG. 23 correspond to the instantaneous power plots of FIG. 25. The plots of FIG. 25 display the mechanical outputs wherein α_{inductance} is equal to: 1, 1.000025, 1.00005, and 1.0001. Additionally, it displays the combined torque proportionality of FIG. 16 for comparison. FIG. 25.a displays the instantaneous combined mechanical power associated with resonant currents and two offset quasi-sinusoidal variable capacitors. Here, the average amount of mechanical power is negative, which is easily inferred by the size of the negative power spikes relative to the positive spikes. Furthermore, as the circuits' inductances increase by 1.000025 in FIG. 25.b, the difference between the two power spikes decreases, thus requiring a smaller amount of average mechanical power. Comparing this plot to its corresponding value in FIG. 23, identifies this variation as a generator with over-unity efficiency, because its Ave Output is positive. FIG. 25.c displays how increasing the circuits' inductances enable the device to begin producing mechanical rotation. When this plot is compared to its corresponding value in FIG. 23, one can infer that the device is capable of operating as both a generator and a motor simultaneously as is shown in FIG. 25.d and FIG. 22.

The average outputs of a single-assembly embodiment's variations are displayed in the table of fifteen variations in FIG. 26. These variations have inductances, α_{inductance}, of either 1, 1.000025, 1.00005, or 1.0001, with electrical loads, Road, of either 0, 25, 50, or 100-Ohms. Additionally, each of these variations has 15-Ohms of internal resistance. The DC voltage and rate of rotation of the rotor are equal for all variations. FIG. 26 displays the induced current's equivalent mechanical phase angle, measured in degrees and the average electrical and mechanical outputs of these variations, as well as their combined average output in Watts.

If energy were conserved, then the average outputs for the variations in FIG. 26 would be equal to the energy dissipated by the circuit's 15-Ohms of internal resistance and that which is flowing into the DC voltage source. However, because the electric field's work is conserved, these average outputs are equal to the amount of energy created or destroyed. These average outputs plus the energy dissipated by the circuit's internal resistance and that which is flowing into the DC voltage source, are equal to the device's total energy yield per variation. The energy dissipated by the mechanical, magnetic, and electrical resistances is conserved. When the device is operating as a motor, such as in the fourth variation of FIG. 26, only part of the Ave Mechanical Power is usable. For example, some of this mechanical power is converted into heat within the device's bearings. The Ave Mechanical Power of FIG. 26 is equal to the maximum mechanical output per variation, prior to subtracting losses due to friction. The energy dissipated by the mechanical resistances have not been addressed as they are embodiment dependent. However, induction motors experience these same resistances but cannot create energy because their magnetic fields do no work. Therefore, this quasi-electrostatic motor is inherently more useful than induction motors due to the electric field's ability to do work.

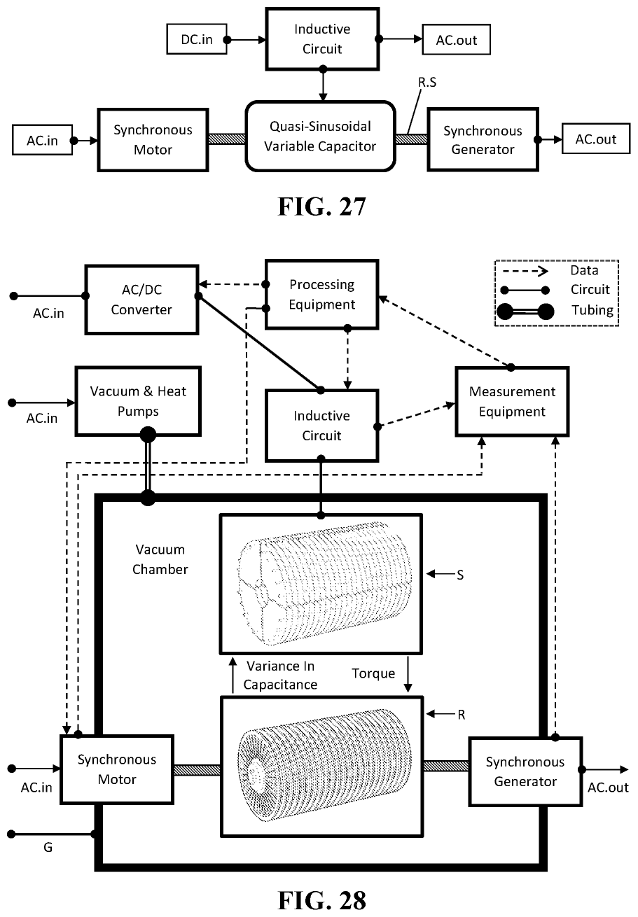

The quasi-sinusoidal variable capacitor requires constant rotation of its rotor to induce a stable alternating current. The quasi-sinusoidal variable capacitor can also provide rotation to its rotor when a lagging current is established from an inductive circuit. When these two criteria are met, the device can operate as a motor and a generator simultaneously. FIG. 27 displays a simplified system level view of a quasi-sinusoidal variable capacitor in-line with a synchronous motor-generator set. In this mode, the synchronous motor maintains a constant rate of rotation of the device's rotor. A DC voltage is supplied to the stator's inductive circuit. The combination of these provides both usable mechanical energy to a generator and electrical energy to an electrical load. FIG. 24 displays the device's average outputs when the rotor's rate of rotation and α_{inductance} are constant. The voltage source DC.in is then turned on at time zero. This graph illustrates that the synchronous motor of FIG. 27 is required to provide an additional amount of mechanical energy to the rotor as the device's inductive circuit establishes a lagging current.

FIG. 28 displays an in-depth system level view of the quasi-sinusoidal variable capacitor. Here, some of the device's supportive components are displayed. Various lines are implemented within FIG. 28 to symbolize connections between the components and a legend is provided specifying the meanings of these various lines. The system displayed in FIG. 28, like that of FIG. 27, is of a quasi-sinusoidal variable capacitor in-line with a motor-generator set. However, this device is held within a grounded vacuum chamber which is maintained by vacuum and heat pumps. Additionally, the voltage from the AC/DC converter is controlled by the system's measurement and processing equipment to ensure optimal performance. The circuit's inductance can also be regulated through the use of digitally controlled variable inductors. Unlike induction motors, the quasi-sinusoidal variable capacitor cannot automatically adjust to a changing mechanical load. Therefore, some embodiments require measuring and processing equipment to adjust the circuit's inductance and/or its DC voltage to maintain optimal operation.

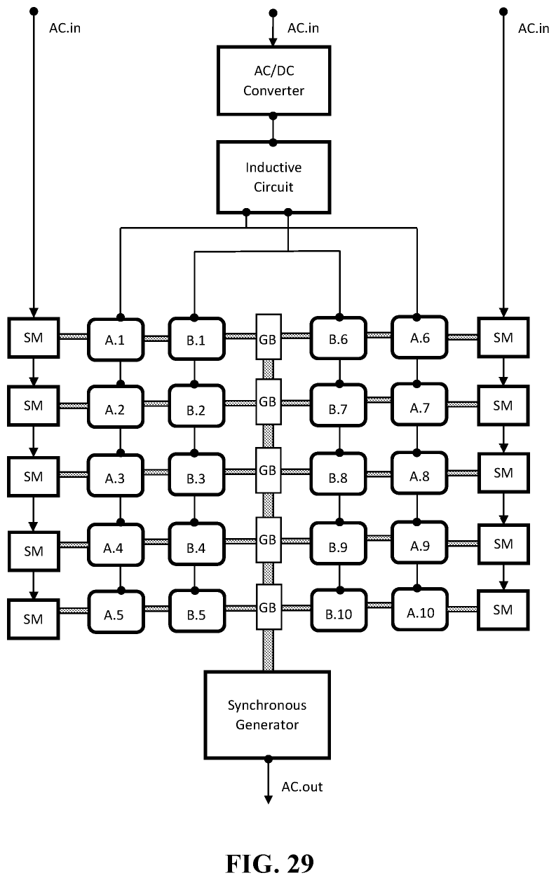

The quasi-sinusoidal variable capacitor can operate as a stand-alone assembly as displayed in FIG. 27 and FIG. 28, or as a system of assemblies working in unison, as displayed in FIG. 29. Here, a system of quasi-sinusoidal variable capacitors provides mechanical energy to a single generator. This system benefits from the assemblies' capacitors being connected in parallel because it reduces the size of the circuit's inductance without reducing the torque proportionality per assembly. This is beneficial because the torque proportionality's amplitude is shown to increase as the stator's capacitance decreases in equation (3). The maximum output of a single inductive circuit can be increased by using many quasi-sinusoidal variable capacitors together in parallel.

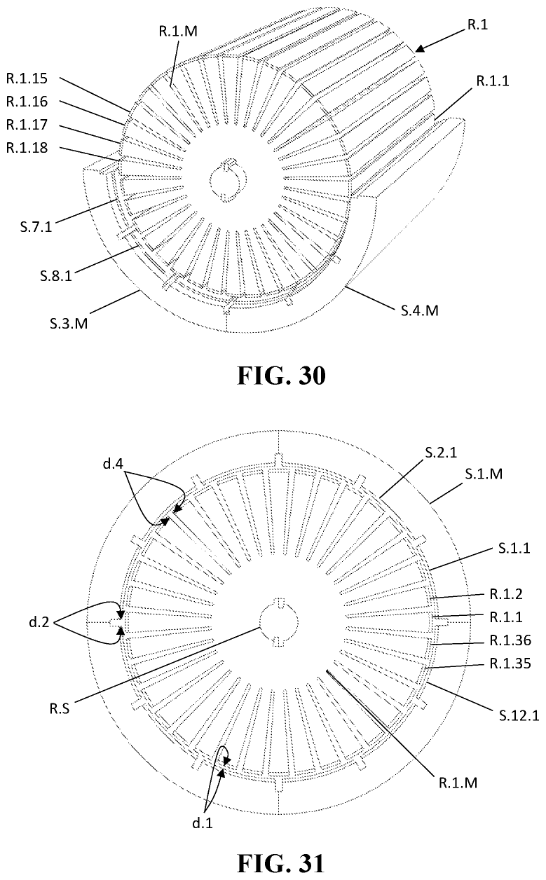

The quasi-sinusoidal variable capacitor of FIG. 1 with its many parallel rotor discs was identified as a coplanar embodiment. However, other geometries can be designed that have an increased torque proportionality because of their stator's increased rate of change in capacitance and decreased capacitance. FIG. 30 displays a coaxial embodiment of a quasi-sinusoidal variable capacitor. Here, the rotor mount R.1.M is cylindrical with a height nearly equal to that of its stator mount S.4.M. This embodiment's rotor mount houses thirty-six rotor segments which are partially specified as R.1.1 and R.1.15-R.1.18. The rotor segments of FIG. 30 are fastened tangentially to the rotor mount, whereas the rotor segments of FIG. 2 are fastened radially. The coaxial embodiment's stator plates, which are partially specified as S.7.1 and S.8.1, are similarly fastened tangentially to the stator mount S.3.M. Multiple stator pole plates can be fastened to a single stator mount in a coaxial embodiment. For example, the stator pole plates S.7.1-S.9.1 are fastened to the stator pole mount S.3.M. The coaxial embodiment has only one stator pole plate per pole and has only one rotor disc per assembly. The identification of S.7.1 and R.1 are used only for comparison to the coplanar embodiment of FIG. 2.

FIG. 31 illustrates some of the coaxial embodiment's important geometric features. The distances d.2 and d.4 are specified as being the distance between the stator pole plates and the distance between the rotor segments, respectively. Similar to the coplanar embodiment, this device has a maximum capacitance when the overlap between a rotor segment, such as R.1.1, and two stator pole plates, such as S.1.1 and S.12.1, is at a maximum. Likewise, the device's capacitance is at a minimum when the distance d.4 is squarely between these stator pole plates. The device's maximum rate of change in capacitance occurs when the rotor segments either enter or exit their neighboring stator pole plates, which is preferably halfway between its minimum and maximum capacitances. A quasi-sinusoidal variance in capacitance is established from unequal rates of change in electrostatic induction prior to and after the waveform's medians.

The coaxial embodiment benefits from a decreased length of distance d.1, which can be shorter than a coplanar embodiment's distance d.1. This is due to it being normal to the axis of rotation of the rotor, rather than within the plane of rotation. The possible amplitudes of displacement of the rotor discs and stator pole plates are much less in the coaxial embodiment than in the coplanar embodiment. As denoted by the stator pole plate S.12.1, the coaxial embodiment can also implement more stator poles than its counterpart. This is because the stator pole plates within the coplanar embodiment have a greater risk of displacement into the distance d.1, as their structural support from the stator mount decreases, as illustrated in FIG. 3. The coaxial embodiment of FIG. 30 and FIG. 31 is but one example of another geometry of a quasi-sinusoidal variable capacitor, which has a larger torque proportionality than the coplanar embodiment of FIG. 1 because of its smaller displacement tolerances.

The above description provides examples of the structures and uses of the invention as defined in the claims. An argument in favor of the revisitation of the law of conservation of energy was presented in the background of the invention. This was followed by the disclosure of its modified variation, the law of conservation of work, in the summary of the invention. It is important to note that the law of conservation of work is not being claimed within this disclosure. Rather, the subject of the claims is an invention capable of creating energy from the work added to it by the electric fields within it. The law of conservation of work states: work added independently to a system from the electric fields within it is conserved, therefore this work can be used to create energy. Energy can be created with the work added from the electric fields of a lagging alternating stator charge within the quasi-sinusoidal variable capacitor. This alternating charge has a peak occurring while the stator's capacitance is slowly decreasing, and another peak occurring while the stator's capacitance is quickly increasing. Therefore, the quasi-sinusoidal variable capacitor is capable of creating energy from the work added to it by the electric fields within it, because the electric fields themselves do work.

What is claimed is:

1. A quasi-sinusoidal variable capacitor comprising:
a plurality of stator poles comprising one or more stator pole plates, wherein the one or more stator pole plates are conductive, and wherein each of the plurality of stator poles are separated such that a mutual electrical capacitance is formed between the plurality of stator poles thereby contributing to a capacitance of the plurality of stator poles;
a rotor shaft configured to transfer a rotor torque to and from said quasi-sinusoidal variable capacitor;
a rotor mount supported on and fixedly attached to said rotor shaft such that rotation of the rotor shaft causes a corresponding rotation of the rotor mount, wherein the rotor mount is electrically insulating, and wherein the rotor mount is rotatable to said plurality of stator poles; and
a plurality of rotor segments equally spaced and fixedly attached to said rotor mount, wherein each of the plurality of rotor segments are electrically insulated from one another, from said rotor shaft, and from said plurality of stator poles, and wherein rotation of the plurality of rotor segments establishes a quasi-sinusoidal variance in capacitance of the capacitance of the plurality of stator poles.

2. The quasi-sinusoidal variable capacitor of claim 1, wherein the quasi-sinusoidal variable capacitor is housed within a vacuum chamber.

3. The quasi-sinusoidal variable capacitor of claim 1, further comprising:
an electrical circuit, the electrical circuit comprising an external voltage source, an electrical resistance, and an inductor, wherein each of said plurality of stator poles are electrically connected to the electrical circuit such that said quasi-sinusoidal variance in capacitance of the capacitance of the plurality of stator poles induces an alternating current within the electrical circuit.

4. The quasi-sinusoidal variable capacitor of claim 1, further comprising:
an electrical circuit, the electrical circuit comprising an external voltage source, and an inductor, wherein each of said plurality of stator poles are electrically connected to the electrical circuit such that said quasi-sinusoidal variance in capacitance of the capacitance of the plurality of stator poles induces an alternating current within the electrical circuit.

5. The quasi-sinusoidal variable capacitor of claim 3, wherein a motor is rotatably coupled to said rotor shaft such that the motor provides said rotor torque to the rotor shaft, and wherein said alternating current produces electrical energy within said electrical resistance of said electrical circuit.

6. The quasi-sinusoidal variable capacitor of claim 4, wherein a generator is rotatably coupled to said rotor shaft such that said rotor torque is provided to the generator, and wherein the rotor torque is converted into electrical energy within the generator.

7. The quasi-sinusoidal variable capacitor of claim 3, wherein the quasi-sinusoidal variable capacitor is rotatably coupled with a motor-generator set such that said rotor torque is added to a torque of the motor-generator set, and wherein said alternating current produces electrical energy within said electrical resistance of said electrical circuit.

8. The quasi-sinusoidal variable capacitor of claim 4, wherein the quasi-sinusoidal variable capacitor is rotatably coupled with a motor-generator set such that said rotor torque is added to a torque of the motor-generator set.

9. The quasi-sinusoidal variable capacitor of claim 1, wherein said quasi-sinusoidal variance in capacitance of the capacitance of the plurality of stator poles comprises a maximum capacitance, a minimum capacitance, and two median capacitances, wherein the median capacitances are midway between the maximum and minimum capacitances, and wherein the rates of change on either side of the two medians are unequal such that a mean capacitance of the quasi-sinusoidal variance in capacitance of the capacitance of the plurality of stator poles is unequal to the median capacitances.

10. The quasi-sinusoidal variable capacitor of claim 1, wherein said one or more stator pole plates are chemically etched to increase their surface area such that the rotation of said plurality of rotor segments establishes an increased variance in said quasi-sinusoidal variance in capacitance of the capacitance of the plurality of stator poles.

11. The quasi-sinusoidal variable capacitor of claim 1, wherein said plurality of rotor segments are chemically etched to increase their surface area such that the rotation of the etched plurality of rotor segments establishes an increased variance in said quasi-sinusoidal variance in capacitance of the capacitance of the plurality of stator poles.

12. The quasi-sinusoidal variable capacitor of claim 1, wherein said plurality of rotor segments are divided into smaller rotor segment parts to reduce an amplitude of eddy currents induced by electromagnetic fields.

13. The quasi-sinusoidal variable capacitor of claim 1, wherein said rotor mount is slotted between said plurality of rotor segments such that an electrical permittivity between the plurality of rotor segments is less than that of the rotor mounts.

14. The quasi-sinusoidal variable capacitor of claim 1, wherein the quasi-sinusoidal variable capacitor is one of a plurality of quasi-sinusoidal variable capacitors that are operated in unison.

15. The quasi-sinusoidal variable capacitor of claim 14, wherein a rate of change in capacitance of at least one of said plurality of quasi-sinusoidal variable capacitors is increasing while the rate of change in capacitance of at least one of the plurality of quasi-sinusoidal variable capacitors is decreasing.

16. The quasi-sinusoidal variable capacitor of claim 9, wherein said quasi-sinusoidal variance in capacitance of the capacitance of the plurality of stator poles has a variance in which its mean is larger than its medians such that its variance is changing more quickly prior to its first median than it is after its first median, and its variance is changing more slowly prior to its second median than it is after its second median.

17. The quasi-sinusoidal variable capacitor of claim 16, further comprising:
an inductive circuit, the inductive circuit comprising an external voltage source and an inductor, wherein each set of said plurality of stator poles are electrically connected to the inductive circuit such that said quasi-sinusoidal variance in capacitance of the capacitance of the plurality of stator poles induces an alternating current within the inductive circuit, and wherein an inductance of the inductor is larger than a resonant inductance of the inductive circuit such that said alternating current is shifted into a lagging alternating current.

18. The quasi-sinusoidal variable capacitor of claim 9, wherein said quasi-sinusoidal variance in capacitance of the capacitance of the plurality of stator poles has a variance in which its mean is smaller than its medians such that its variance is changing more slowly prior to its first median than it is after its first median, and its variance is changing more quickly prior to its second median than it is after its second median.

19. The quasi-sinusoidal variable capacitor of claim 18, further comprising:
a capacitive circuit, the capacitive circuit comprising an external voltage source and an inductor, wherein each set of said plurality of stator poles are electrically connected to the capacitive circuit such that said quasi-sinusoidal variance in capacitance of the capacitance of the plurality of stator poles induces an alternating current within the capacitive circuit, and wherein an inductance of the inductor is smaller than a resonant inductance of the capacitive circuit such that said alternating current is shifted into a leading alternating current.

20. The quasi-sinusoidal variable capacitor of claim 1, wherein said plurality of rotor segments has a greater conductivity than a conductivity between the plurality of rotor segments.
